(19) United States
(12) Patent Application Publication
(10) Pub. No.: US 2024/0003703 A1
(43) Pub. Date: Jan. 4, 2024

(54) INFORMATION PRESENTATION METHOD, INFORMATION PRESENTATION DEVICE, AND PROGRAM

(71) Applicant: NIPPON TELEGRAPH AND TELEPHONE CORPORATION, Tokyo (JP)

(72) Inventors: Tatsuaki ITO, Tokyo (JP); Yusuke ICHIKAWA, Tokyo (JP); Sayaka TERANAKA, Tokyo (JP); Shunsuke KONAGAI, Tokyo (JP); Hirofumi ABE, Tokyo (JP)

(73) Assignee: NIPPON TELEGRAPH AND TELEPHONE CORPORATION, Tokyo (JP)

(21) Appl. No.: 18/038,438

(22) PCT Filed: Nov. 26, 2020
(86) PCT No.: PCT/JP2020/043927

§ 371 Date: May 23, 2023

(51) Int. Cl. G01C 21/36; G01C 21/34

(52) U.S. Cl. CPC G01C 21/3691; G01C 21/3423

(57) ABSTRACT

A server (20) as an information presentation device according to the present disclosure includes a route search unit (23) that searches for the moving route, and
a route information forming unit (24) as an information presentation unit that, in a case where the searched moving route includes a plurality of partial routes having different moving means, adds congestion information regarding a congestion status of the moving route as a whole according to a congestion degree of each of the plurality of partial routes to the moving route and presents the congestion information to the user.

### TECHNICAL FIELD

The present disclosure relates to an information presentation method, an information presentation device, and a program.

### BACKGROUND ART

In recent years, in consideration of the required time, the number of times of transfer, and the like, information presentation has been performed in which a moving route from a departure place to a destination of a user, that combines public transportation means such as a train, moving means such as an automobile, and walking, is searched for and presented to the user.

Depending on the moving means described above, the required time may change depending on the number of people who simultaneously use the route using the moving means. Therefore, the congestion status of the route is of great interest to the user. In addition, even in a case where the difference in required time due to the congestion status is not large, the congestion of the route may cause physical and mental pain to the user who uses the route. Therefore, the congestion status is a matter to be sufficiently considered in the selection of the moving route.

Patent Literature 1 describes a technique for presenting information (hereinafter, referred to as “congestion information”) regarding a congestion status in a route using public transportation means such as a train to a user. In the technique described in Patent Literature 1, a current congestion status of a desired carriage in each vehicle and congestion transition information for each vehicle up to an alighting station of the user are presented to the user at a platform of a station. In addition, Patent Literature 2 discloses a technique of presenting congestion information in a route using an automobile or walking to a user. In the technique described in Patent Literature 2, the future numbers of arbitrary moving objects (pedestrians, automobiles, bicycles, or the like) moving on a road are estimated and presented for each of roads.

### CITATION LIST

### Patent Literature

Patent Literature 1: JP 2007-249705 A
Patent Literature 2: JP 2020-140333 A

### SUMMARY OF INVENTION

### Technical Problem

The moving route from a departure place to a destination may include a plurality of routes (hereinafter, it is referred to as a “partial route”) with different moving means. As described above, the congestion status should be sufficiently considered in the selection of the moving route. The techniques described in Patent Literature 1 and 2 are techniques for presenting congestion information in a route using single moving means, and do not sufficiently consider the congestion status of the moving route as a whole. Therefore, there is a problem that it is necessary for the user to acquire congestion information of each partial route constituting the moving route and for the user to determine the congestion status of the moving route as a whole himself/herself based on the acquired congestion information of each partial route.

An object of the present disclosure made in view of the above problems is to provide an information presentation method, an information presentation device, and a program capable of presenting, to a user, a congestion status of a moving route as a whole including a plurality of partial routes.

### Solution to Problem

In order to solve the above problem, an information presentation method according to the present disclosure is an information presentation method for presenting a moving route from a departure place to a destination designated by a user, the method including a search step of searching for the moving route, and a presentation step of, in a case where the searched moving route includes a plurality of partial routes having different moving means, adding congestion information regarding a congestion status of the moving route as a whole according to a congestion degree of each of the plurality of partial routes to the moving route and presenting the congestion information to the user.

In addition, in order to solve the problem, an information presentation device according to the present disclosure is an information presentation device that presents a moving route from a departure place to a destination designated by a user, the device including a route search unit that searches for the moving route, and an information presentation unit that, in a case where the searched moving route includes a plurality of partial routes having different moving means, adds congestion information regarding a congestion status of the moving route as a whole according to a congestion degree of each of the plurality of partial routes to the moving route and presents the congestion information to the user.

In order to solve the above problems, a program according to the present disclosure causes a computer to function as the above-described information presentation device.

### Advantageous Effects of Invention

According to the information presentation method, the information presentation device, and the program according to the present disclosure, it is possible to present the congestion status of the moving route as a whole including a plurality of partial routes to the user.

### BRIEF DESCRIPTION OF DRAWINGS

FIG. 1 is a diagram illustrating a configuration example of an information presentation system including an information presentation device according to an embodiment of the present disclosure.

FIG. 2 is a flowchart illustrating an example of an operation of the information presentation device illustrated in FIG. 1.

FIG. 3 is a diagram illustrating an example of information presentation by a route information forming unit illustrated in FIG. 1.

FIG. 4 is a diagram illustrating another example of information presentation by the route information forming unit illustrated in FIG. 1.

FIG. 5 is a diagram illustrating still another example of information presentation by the route information forming unit illustrated in FIG. 1.

FIG. 6 is a diagram illustrating still another example of information presentation by the route information forming unit illustrated in FIG. 1.

### DESCRIPTION OF EMBODIMENTS

Hereinafter, an embodiment of the present disclosure will be described with reference to the drawings.

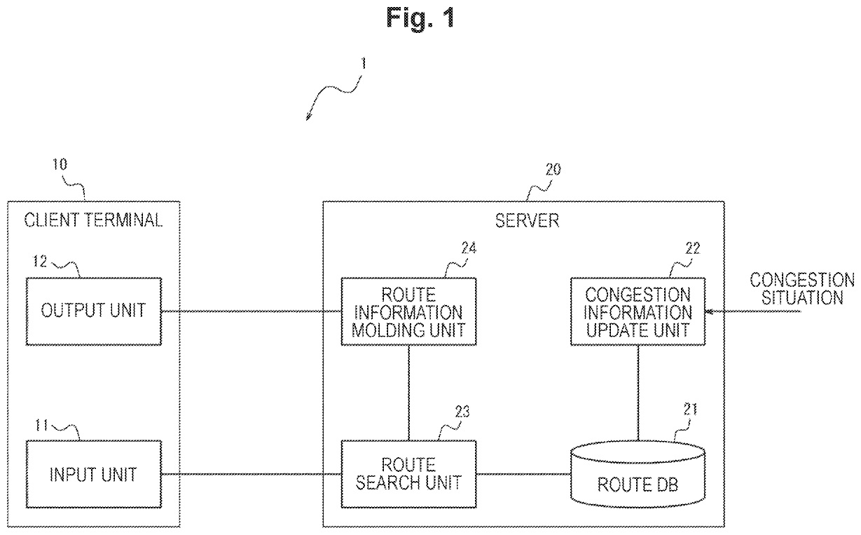

FIG. 1 is a diagram illustrating a configuration example of an information presentation system 1 including a server 20 as an information presentation device according to an embodiment of the present disclosure. The information presentation system 1 according to the present embodiment presents, to a user, congestion information regarding a congestion status of a moving route as a whole including a plurality of routes (partial routes) using different moving means from a departure place designated by the user to a destination.

As illustrated in FIG. 1, the information presentation system 1 according to the present embodiment includes a client terminal 10 and the server 20.

The client terminal 10 is a terminal used by a user who checks a moving route from a departure place to a destination. The client terminal 10 is, for example, a smartphone, a tablet terminal, a personal computer (PC), or the like. The client terminal 10 has a function of receiving an operation input of the user and a function of presenting information to the user.

The server 20 is a computer that provides a route information presentation service for presenting information regarding a moving route. The server 20 is installed on a network such as the Internet, for example, and can communicate with the client terminal 10 via the network. The server 20 provides a route information presentation service to the client terminal 10 via the network.

Next, configurations of the client terminal 10 and the server 20 will be described. First, the configuration of the client terminal 10 will be described.

As illustrated in FIG. 1, the client terminal 10 includes an input unit 11 and an output unit 12.

The input unit 11 receives an operation input by the user. The input unit 11 is, for example, a keyboard, a touch panel, or the like. Upon receiving an operation input designating a departure place, a destination, a departure date and time, an arrival date and time, and the like, the input unit 11 transmits a search request for a moving route including the input departure place, destination, departure date and time, arrival date and time, and the like to the server 20.

The output unit 12 presents various types of information items provided from the server 20 to the user. The output unit 12 is, for example, a display or the like included in the client terminal 10, and displays information provided from the server 20 and presents the information to the user. The output unit 12 may present the information provided from the server 20 to the user by, for example, voice output or the like.

Next, a configuration of the server 20 as the information presentation device according to the present embodiment will be described.

As illustrated in FIG. 1, the server 20 includes a route database (DB) 21, a congestion information update unit 22, a route search unit 23, and a route information forming unit 24 as an information presentation unit.

The route DB 21 includes an arbitrary memory such as a hard disk drive (HDD), a solid state drive (SSD), an electrically erasable programmable read only memory (EEPROM), a read-only memory (ROM), and a random access memory (RAM).

The route DB 21 stores information regarding a plurality of moving routes from an arbitrary departure place to a destination. The information regarding one moving route includes, for example, node information (a departure place and a destination), moving means (a train, an automobile, walking, or the like), a required time, congestion information on a partial route constituting the moving route, information regarding barrier free response situations (for example, a response status for a user with hearing and visual disabilities (for example, presence or absence of a Braille block, a voice guidance device, or the like), and a response status for a wheelchair/baby carriage user (for example, the presence or absence of a slope, an elevator, or the like)), and the like. The congestion information of the partial route may include congestion information for each time period.

The congestion information update unit 22 regularly or irregularly acquires the congestion status for each partial route from the outside, and generates congestion information for each partial route. For example, the congestion information update unit 22 generates congestion information of a partial route by calculating a value (congestion degree) obtained by quantifying the congestion status of the acquired partial route. For each of the plurality of partial routes constituting the moving route, the congestion information update unit 22 may calculate the congestion degree for each time period using statistics of past congestion status, future congestion prediction, and the like, and generate congestion information for each time period. For the generation of congestion information of a partial route (a route using a single moving means), any existing technology such as the technologies described in Patent Literature 1 and 2 described above can be used, and thus the description thereof will be omitted. The congestion information update unit 22 updates the congestion information of the corresponding partial route stored in the route DB 21 based on the generated congestion information of the partial route.

Upon receiving the search request from the client terminal 10, the route search unit 23 searches the route DB 21 for the moving route from the departure place to the destination included in the search request. In a case where the departure time or the arrival time is included in the search request, the route search unit 23 searches for a moving route of departure or arrival in accordance with the time. Any existing method can be used for the search of the moving route by the route search unit 23, and thus the description thereof will be omitted.

The route search unit 23 acquires the searched moving route, congestion information for each partial route included in the moving route, information on barrier free handling situations for each partial route, and the like from the route DB 21, and outputs the acquired information to the route information forming unit 24.

The route information forming unit 24 forms information such as the moving route searched for by the route search unit 23 into a predetermined display format and transmits the display format to the client terminal 10. The information transmitted to the client terminal 10 is presented to the user by being displayed by the output unit 12 or the like. In a case where the searched moving route includes a plurality of partial routes having different moving means, the route information forming unit 24 adds congestion information of the moving route as a whole according to the congestion degree of each of the plurality of partial routes to the moving route and presents the moving route to the user.

In a case where the moving route includes a plurality of partial routes, the route information forming unit 24 calculates the congestion degree of the moving route as a whole based on the congestion information of each of the plurality of partial routes. For example, it is assumed that the moving route includes a partial route A, a partial route B, and a partial route C, and the congestion degree is indicated in a range of 0.0 to 3.0. For example, when the congestion degree of the partial route A is 2.4, the congestion degree of the partial route B is 1.7, and the congestion degree of the partial route C is 2.6, the route information forming unit 24 calculates an average value of the congestion degrees of the partial routes A, B, and C as ((2.4+1.7+2.6)/3=2.3 (rounded off to the first decimal place)) as the congestion degree of the moving route as a whole. The method of calculating the congestion degree of the moving route as a whole is not limited to the method described above. For example, the route information forming unit 24 may weight the congestion degree of each of the plurality of partial routes constituting the moving route according to the required time of each of the partial routes to calculate the congestion degree of the moving route as a whole.

Next, an operation of the server 20 according to the present embodiment will be described.

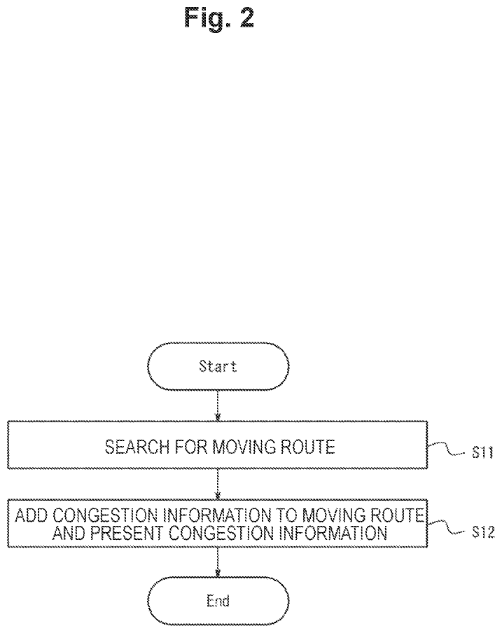

FIG. 2 is a flowchart illustrating an example of the operation of the server 20 according to the present embodiment, and is a diagram for explaining an information presentation method by the server 20 as an information presentation device.

Upon receiving the search request from the client terminal 10, the route search unit 23 searches for a moving route from the departure place to the destination included in the search request (step S11).

The route information forming unit 24 outputs information regarding the moving route searched by the route search unit 23 to the client terminal 10 and presents the information to the user. In a case where the searched moving route includes a plurality of partial routes having different moving means, the route information forming unit 24 generates congestion information regarding the congestion status of the moving route as a whole according to the congestion degree of each of the plurality of partial routes. Then, the route information forming unit 24 adds generated congestion information of the moving route as a whole to the moving route and presents the moving route to the user (step S12).

As described above, the information presentation method according to the present embodiment includes a search step (step S11) and a presentation step (step S12). In the search step, the route search unit 23 searches for a moving route from a departure place to a destination designated by the user. In the presentation step, in a case where the searched moving route includes a plurality of partial routes having different moving means, the route information forming unit 24 adds congestion information regarding a congestion status of the moving route as a whole according to the congestion degree of each of the plurality of partial routes to the moving route and presents the moving route to the user.

Therefore, according to the information presentation method according to the present disclosure, it is possible to present the congestion information as a whole of the moving route according to the congestion degree of each of the plurality of partial routes constituting the moving route to the user.

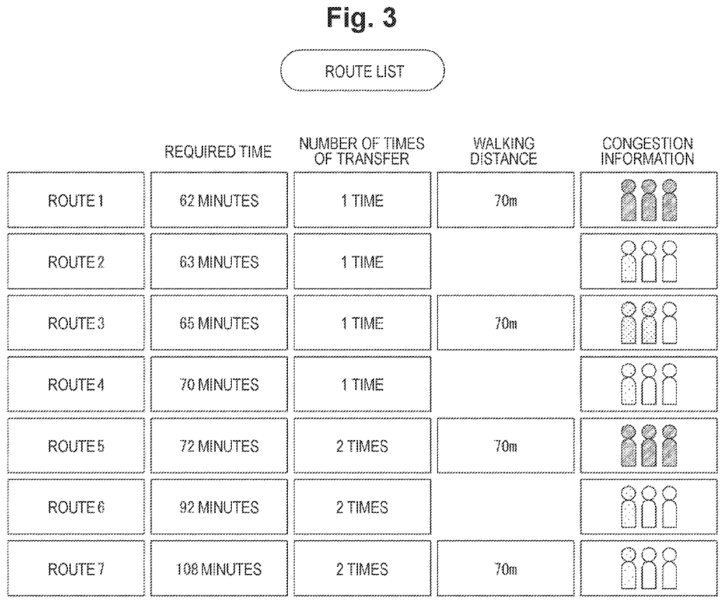

Next, information presentation by the route information forming unit 24 will be described with reference to FIGS. 3 to 6. FIGS. 3 to 6 are diagrams illustrating examples of information presentation by the route information forming unit 24.

FIG. 3 is a diagram illustrating an example of information presentation to which congestion information of the moving route as a whole is added.

In the example illustrated in FIG. 3, the route information forming unit 24 displays a list of a plurality of moving route candidates from a departure place to a destination. The route information forming unit 24 displays the required time, the number of transfers, the distance of walking movement, and congestion information of the moving route as a whole for each moving route. In this manner, by presenting the congestion information of the moving route as a whole for each moving route, the user can determine the moving route in consideration of the congestion information of the entire moving route.

The example illustrated in FIG. 3 illustrates an example in which congestion information as a whole of the moving route is displayed in three stages. As illustrated in FIG. 3, the route information forming unit 24 prepares a human-shaped figure (figure for three people) displayed in a predetermined color in association with each of the plurality of moving routes. Then, the route information forming unit 24 displays some or all figures among the human-shaped figures for three people in a color different from the original color according to the congestion degree as a whole of the moving route. For example, for a moving route in which the congestion degree as a whole is less than 1, the route information forming unit 24 displays one figure among the three human-shaped figures corresponding to the moving route in a color (for example, green) different from the original color. In addition, for example, for a moving route in which the congestion degree as a whole is 1 or more and less than 2, the route information forming unit 24 displays colors of two figures among the three human-shaped figures corresponding to the moving route in a color (for example, yellow) different from the original colors. In addition, for example, for a moving route in which the congestion degree as a whole is 2 or more, the route information forming unit 24 displays all three corresponding figures corresponding to the moving route in a color (for example, red) different from the original color. In FIG. 3, a difference in color is indicated by a difference in hatching. By graphically presenting the congestion information in this manner, the user can intuitively grasp the congestion status of each moving route.

The route information forming unit 24 may present not only the congestion information itself (for example, the congestion degree) of the moving route as a whole but also summarize and present (digest presentation) the congestion information. Summarizing and presenting the congestion information includes not only presenting the congestion information in a graphic form as illustrated in FIG. 3 but also presenting the congestion information in various modes in which the user can intuitively grasp the overall congestion status of the moving route.

The route information forming unit 24 may change the display order by using the congestion degree as a key in the list display of the plurality of moving route candidates. For example, the route information forming unit 24 may display a moving route with a lower congestion degree at a higher level.

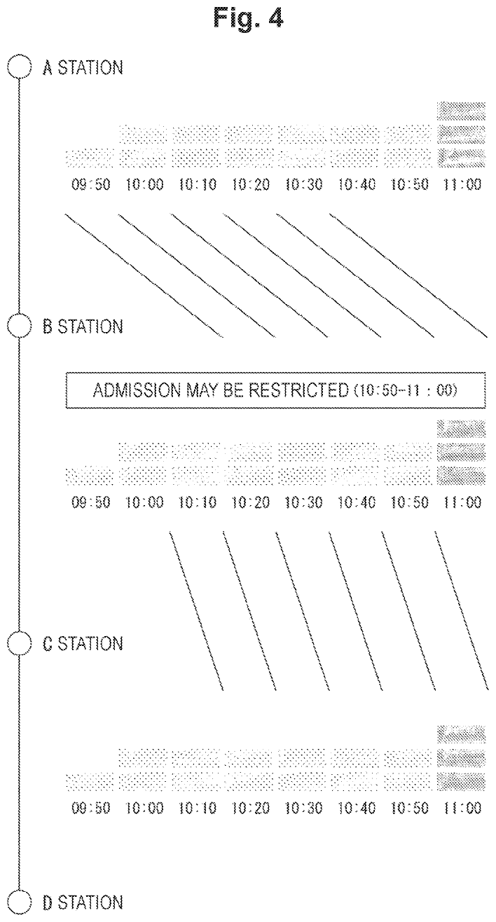

FIG. 4 is a diagram illustrating an example in which the entire moving route is looked down and congestion information of each of a plurality of partial routes constituting the moving route is presented as congestion information of the moving route as a whole. For example, in a case where one moving route is selected from a list of a plurality of moving route candidates illustrated in FIG. 3, information presentation of the entire one moving route as illustrated in FIG. 4 is performed.

In the example illustrated in FIG. 4, the route information forming unit 24 displays three partial routes (a partial route from a station A to a station B, a partial route from the station B to a station C, and a partial route from the station C to a station D) constituting a moving route from the departure place (the station A) to the destination (the station D). Further, the route information forming unit 24 presents congestion information of each of the three partial routes. Specifically, the route information forming unit 24 presents congestion information for each time period of each of the three partial routes A, B, and C. Furthermore, the route information forming unit 24 may connect time periods in which use of each partial route is assumed with a line based on the required time of each partial route. In this way, the user can grasp the congestion status over time when moving along the moving route from the departure place to the destination.

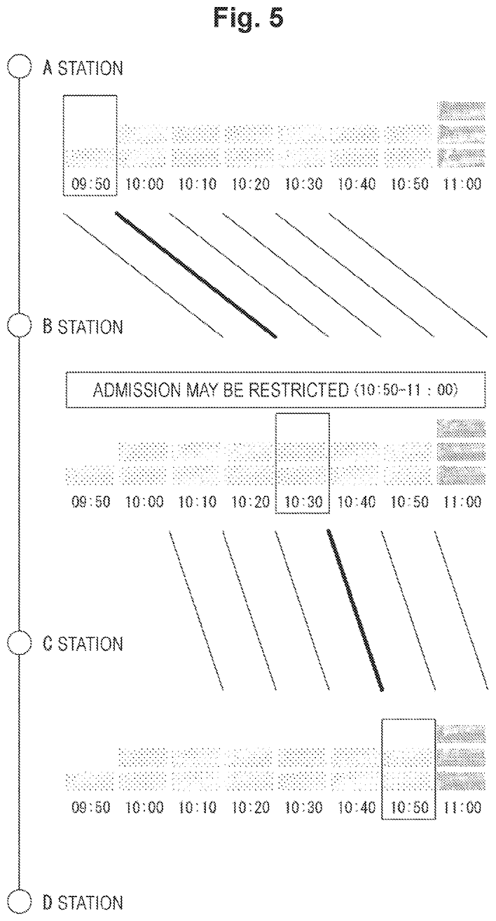

In addition, when the departure time from the departure place or the arrival time to the destination is designated, the route information forming unit 24 may present congestion information in a time period in which each of the plurality of partial routes constituting the moving route is assumed to be used in a case of moving according to the moving route in accordance with the designated time. For example, as illustrated in FIG. 5, the route information forming unit 24 may highlight congestion information in a time period in which each of the plurality of partial routes constituting the moving route is assumed to be used in a case of moving according to the moving route in accordance with the designated time. In the example illustrated in FIG. 5, the route information forming unit 24 surrounds the congestion information in a time period in which each of the plurality of partial routes is assumed to be used in a rectangle and highlights the congestion information. In addition, as illustrated in FIG. 5, the route information forming unit 24 may highlight a line connecting time periods in which each of the plurality of partial routes is assumed to be used. In a case where the departure time and the arrival time are not designated, for example, the route information forming unit 24 may highlight the congestion information in the first time period among the time periods in which the congestion information is presented.

In addition, the route information forming unit 24 may switch a time period in which the congestion information of each of the plurality of partial routes constituting the moving route is presented. For example, when an operation of advancing or delaying the time period for presenting the congestion information by a predetermined time is performed, the route information forming unit 24 may present the congestion information of each of the plurality of partial routes in the time period after the change. For example, an operation button for advancing or delaying the time period for presenting the congestion information by a predetermined time (for example, 10 minutes) may be displayed on the output unit 12, and the change of the time period for presenting the congestion information may be performed by an operation input to the operation button. For example, the route information forming unit 24 may move the emphasized display back and forth according to an operation of advancing or delaying the time period for presenting the congestion information. In this way, since the congestion status in each time period is clearly indicated by highlighting, the user can determine a time period preferable for movement in consideration of the congestion status in the time periods before and after the desired time.

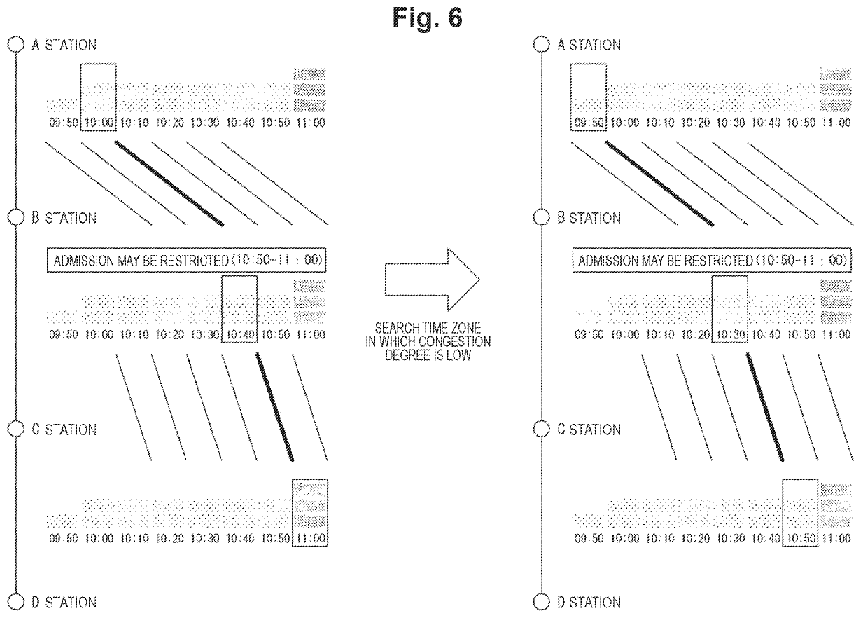

In addition, the route information forming unit 24 may present a time period in which the congestion degree of the moving route as a whole is small based on the congestion information for each time period of each of the plurality of partial routes constituting the moving route. Specifically, for example, the route information forming unit 24 may search for and present a time period in which the congestion degree of the moving route as a whole is small within a range of a predetermined time (for example, 30 minutes) before and after the time designated as the departure time or the arrival time. Therefore, for example, as illustrated in FIG. 6, the route information forming unit 24 may recommend a time period earlier or later than a time period in which each of the plurality of partial routes constituting the moving route is used in accordance with the designated time. FIG. 6 illustrates an example in which congestion information in a recommended time period is surrounded by a rectangle and displayed, and a time period in which each of a plurality of partial routes is assumed to be used is connected by a thick line and highlighted.

The range for searching for a time period with a low congestion degree before and after the designated time may be set by the user or may be set in advance in the system. Note that the route information forming unit 24 calculates the congestion degree of the moving route as a whole in each time period within a predetermined time range before and after the designated time, and presents, for example, a time period in which the calculated congestion degree is minimum. The congestion degree can be calculated, for example, as described above, as an average of the congestion degree of each of the plurality of partial routes constituting the moving route.

In the present embodiment, the server 20 considers factors that make it difficult for the user to move (whether a wheelchair is used, whether a baby carriage is used, whether the user has a hearing or visual impairment), or the like, in addition to the congestion degree and may present the moving route. In this case, the server 20 receives, for example, designation of a departure place, a destination, a departure time, an arrival time, and the like, and input of the presence or absence of use of a wheelchair or a baby carriage, the presence or absence of hearing or visual disability, and the like. The presence or absence of use of a wheelchair or a baby carriage and the presence or absence of hearing or visual disability may be determined, for example, by displaying a selection button for selecting the presence or absence of use of a baby carriage and a selection button for selecting the presence or absence of hearing or visual disability, and performing an operation input to the selection button.

When information regarding factors that make it difficult for the user to move, such as the use of a wheelchair or a baby carriage and the presence of hearing or visual disability, is input together with designation of a departure place, a destination, a departure time, an arrival time, and the like, the route search unit 23 searches for a moving route based on the information. As described above, the route DB 21 stores information on barrier free handling situations in partial routes. The route search unit 23 searches for a moving route in consideration of factors that make it difficult for the user to move based on these pieces of information. For example, in a case where the user uses a wheelchair or a baby carriage, the route search unit 23 searches for a moving route in which a slope or an elevator is installed. The route search unit 23 may search for a moving route that can cope with use of a wheelchair or a baby carriage and a moving route that can cope with hearing and visual disabilities regardless of presence or absence of information regarding a factor that makes it difficult for the user to move. Note that any existing method can be used for searching for a moving route that can cope with use of a wheelchair and a baby carriage, a moving route that can cope with hearing and visual disabilities, and the like, and thus the description thereof will be omitted.

As described above, the server 20 as the information presentation device according to the present embodiment includes the route search unit 23 and the route information forming unit 24 as the information presentation unit. The route search unit 23 searches for a moving route. In a case where the searched moving route includes a plurality of partial routes having different moving means, the route information forming unit 24 adds congestion information regarding a congestion status of the entire moving route according to the congestion degree of each of the plurality of partial routes to the moving route and presents the congestion information to the user.

Therefore, according to the present disclosure, it is possible to present the congestion status of the moving route as a whole including the plurality of partial routes to the user. As a result, the user can determine the congestion status of the entire moving route without acquiring the congestion information of each partial route, so that the user can quickly select the moving route in consideration of the congestion status.

A computer can be suitably used to function as each unit of the server 20 described above. Such a computer can be realized by storing a program in which processing contents for realizing the function of each unit of the server 20 are described in a storage unit of the computer and reading and executing the program by a central processing unit (CPU) of the computer. That is, the program can cause the computer to function as the server 20 described above.

Furthermore, the program may be recorded in a computer-readable medium. By using a computer-readable medium, the program can be installed in a computer. Here, the computer-readable medium in which the program is recorded may be a non-transitory recording medium. The non-transitory recording medium is not particularly limited, and may be, for example, a recording medium such as a CD-ROM or a DVD-ROM. Moreover, the program can also be provided via a network.

The present disclosure is not limited to the configuration specified in each of the above-described embodiments, and various modifications can be made without departing from the gist of the invention described in the claims. For example, the functions and the like included in each component and the like can be rearranged so as not to be logically inconsistent, and a plurality of components and the like can be combined into one or can be divided.

### REFERENCE SIGNS LIST

1 Information presentation system
10 Client terminal
11 Input unit
12 Output unit
20 Server (information presentation device)
21 Congestion information update unit
22 Route DB
23 Route search unit
24 Route information forming unit (information presentation unit)

1. An information presentation method for presenting a moving route from a departure place to a destination designated by a user, the method comprising:
searching for the moving route;
when the moving route includes, based on the searching, a plurality of partial routes having different moving means, adding congestion information to the moving route, wherein the congestion information indicates a congestion status of the moving route as a whole according to a congestion degree of each of the plurality of partial routes gf the moving route; and
causing display of the congestion information in addition to the moving route.

2. The information presentation method according to claim 1, wherein the congestion information is in a summarized form.

3. The information presentation method according to claim 1, wherein, when moving according to the moving route in accordance with a time designated by the user, the causing display further causes display of partial congestion information of each of the plurality of partial routes within the moving route in a time period, and wherein the time period corresponds to a time when the user is expected to use each of the plurality of partial routes.

4. The information presentation method according to claim 3, further comprising:
switching the time period in which congestion information of each of the plurality of partial routes within the moving route.

5. The information presentation method according to claim 3,
wherein the causing display further comprises causing display of additional congestion information for each time period of each of the plurality of partial routes within the moving route, wherein the additional congestion information is associated with a time period in which a congestion degree of the moving route as a whole is smaller than an average congestion degree.

6. The information presentation method according to claim 1, wherein the moving route based on a factor that inhibits the user from moving, wherein the factor includes use of a wheelchair.

7. An information presentation device that presents a moving route from a departure place to a destination designated by a user, the information presentation device comprising a processor configured to execute operations comprising:
searching for the moving route; and
when the moving route includes, based on the searching, a plurality of partial routes having different moving means, adds congestion information to the moving route, wherein the congestion information indicates a congestion status of the moving route as a whole according to a congestion degree of each of the plurality of partial routes gf the moving route; and
causing display of the congestion information in addition to the moving route.

8. A computer-readable non-transitory recording medium storing computer-executable program instructions that when executed by a processor cause a computer system to execute operations comprising:
searching for a moving route from a departure place to a destination designated by a user; and
when the moving route includes, based on the searching, a plurality of partial routes having different moving means, adds congestion information to the moving route, wherein the congestion information indicates a congestion status of the moving route as a whole according to a congestion degree of each of the plurality of partial routes of the moving route; and
causing display of the congestion information in addition to the moving route.

9. The information presentation method according to claim 2, wherein the moving route based on a factor that inhibits the user from moving, wherein the factor includes use of a wheelchair.

10. The information presentation device according to claim 7, wherein the congestion information is in a summarized form.

11. The information presentation device according to claim 7, wherein, when moving according to the moving route in accordance with a time designated by the user, the causing display further causes display of partial congestion information of each of the plurality of partial routes within the moving route in a time period, and wherein the time period corresponds to a time when the user is expected to use each of the plurality of partial routes.

12. The information presentation device according to claim 11, the processor further configured to execute operations comprising:
switching the time period in which congestion information of each of the plurality of partial routes within the moving route.

13. The information presentation device according to claim 11, wherein the causing display further comprises causing display of additional congestion information for each time period of each of the plurality of partial routes within the moving route, wherein the additional congestion information is associated with a time period in which a congestion degree of the moving route as a whole is smaller than an average congestion degree.

14. The information presentation device according to claim 7, wherein the moving route based on a factor that inhibits the user from moving, wherein the factor includes use of a wheelchair.

15. The computer-readable non-transitory recording medium according to claim 8, wherein the congestion information is in a summarized form.

16. The computer-readable non-transitory recording medium according to claim 8, wherein, when moving according to the moving route in accordance with a time designated by the user, the causing display further causes display of partial congestion information of each of the plurality of partial routes within the moving route in a time period, and wherein the time period corresponds to a time when the user is expected to use each of the plurality of partial routes.

17. The computer-readable non-transitory recording medium according to claim 16, the computer-executable program instructions when executed further causing the computer system to execute operations comprising:
switching the time period in which congestion information of each of the plurality of partial routes within the moving route.

18. The computer-readable non-transitory recording medium according to claim 16, wherein the causing display further comprises causing display of additional congestion information for each time period of each of the plurality of partial routes within the moving route, wherein the additional congestion information is associated with a time period in which a congestion degree of the moving route as a whole is smaller than an average congestion degree.

19. The computer-readable non-transitory recording medium according to claim 8, wherein the moving route based on a factor that inhibits the user from moving, wherein the factor includes use of a wheelchair.

20. The computer-readable non-transitory recording medium according to claim 15, wherein the moving route based on a factor that inhibits the user from moving, wherein the factor includes use of a wheelchair.
